(19) United States
(12) Patent Application Publication
(10) Pub. No.: US 2025/0392795 A1
(43) Pub. Date: Dec. 25, 2025

(54) MOTION CUSTOMIZATION FOR DIGITAL VIDEOS

(71) Applicant: Adobe Inc., San Jose, CA (US)

(72) Inventors: Yang Zhou, Mountain View, CA (US); Yixuan Ren, Greenbelt, MA (US); Jimei Yang, Mountain View, CA (US); Difan Liu, Amhert, MA (US); Jing Shi, San Jose, CA (US); Feng Liu, Portland, OR (US); Mingi Kwon, Seoul (KR)

(73) Assignee: Adobe Inc., San Jose, CA (US)

(21) Appl. No.: 18/750,642

(22) Filed: Jun. 21, 2024

(51) Int. Cl. H04N 21/81; G06T 7/20; G06T 13/40; H04N 21/84

(52) U.S. Cl. CPC H04N 21/816; G06T 7/20; G06T 13/40; H04N 21/84

(57) ABSTRACT

In implementations of techniques and systems for motion customization in digital videos, a processing device receives a reference digital video, a reference caption, and a target text prompt. The reference digital video includes multiple frames depicting a reference object with a reference movement. The reference caption describes the reference movement and the reference object. The target text prompt indicates a target object with the reference movement for a target digital video. A first aspect of a machine-learning model is trained on frames of the reference digital video with the description of the reference object. Using the first aspect loaded therein, a second aspect of the machine-learning model is trained on the reference digital video with the reference caption. With the second aspect loaded therein and based on the target text prompt, the machine-learning model generates the target digital video depicting the target object with the reference movement.

### BACKGROUND

The ability to generate videos replicating recorded motions with different subjects or scenes is highly desirable for many applications. For example, the movie industry has developed sophisticated visual effects techniques, including motion capture and character animation, to achieve motion replication. However, these conventional techniques are tedious and expensive. These techniques typically involve numerous manual interactions, which results in increased computational resource consumption, reduced user efficiency, and limited flexibility in iterating different ideas for the object, camera motion, or background.

### SUMMARY

Techniques and systems for motion customization in digital videos are described. In one example, a processing device receives a reference digital video, a reference caption, and a target text prompt. The reference digital video depicts a reference movement of a reference object. The reference caption describes the reference movement and the reference object in plain language. The target text prompt indicates a target object mimicking the reference movement for a target video in plain language.

A first aspect of a machine-learning model is trained on frames of the reference digital video with a description of the reference object in the reference caption. The first aspect identifies details and characteristics associated with the reference object. Using the first aspect loaded into the machine-learning model, a second aspect of the machine-learning model is trained on the reference digital video with the reference caption. The second aspect identifies details and characteristics associated with the reference movement. With the second aspect loaded therein, the machine-learning model generates the target digital video of the target object with the reference movement. The processing device then presents the target digital video via a display device.

This Summary introduces a simplified selection of concepts that are further described below in the Detailed Description. As such, this Summary is not intended to identify essential features of the claimed subject matter or to aid in determining its scope.

### BRIEF DESCRIPTION OF THE DRA WINGS

The detailed description is described with reference to the accompanying figures Entities represented in the figures are indicative of one or more entities and thus reference is made interchangeably to single or plural forms of the entities in the discussion.

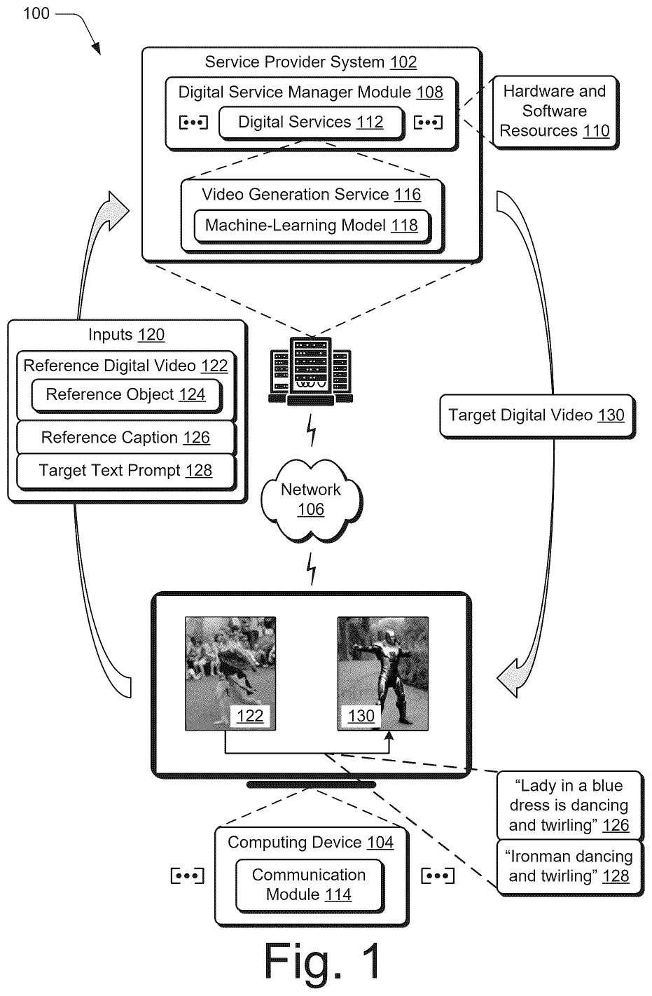

FIG. 1 is an illustration of a digital medium environment in an example implementation that is operable to employ motion customization techniques for digital video generation as described herein.

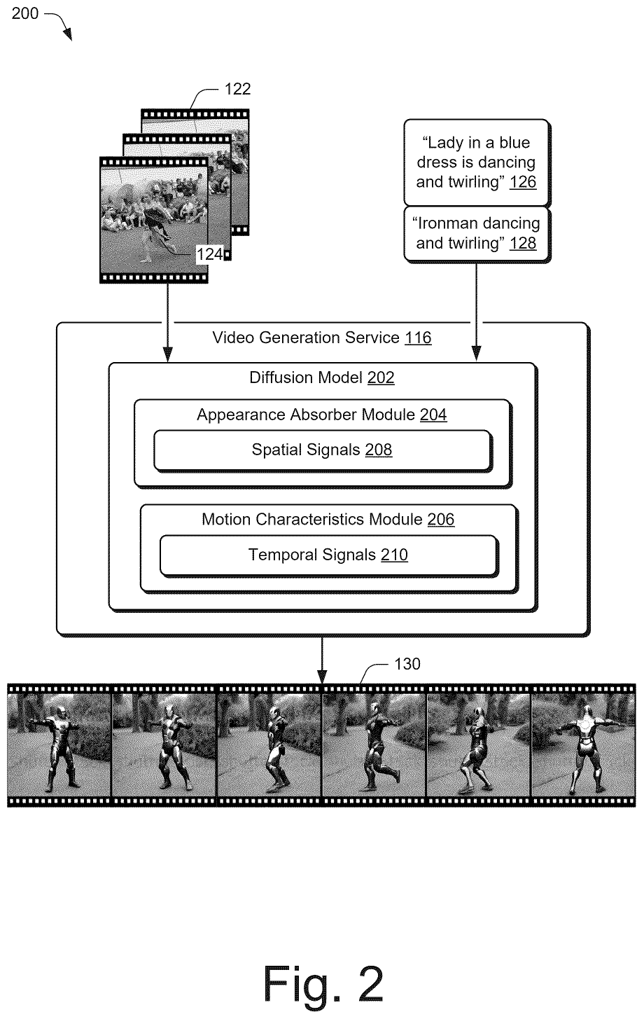

FIG. 2 depicts a system in an example implementation showing operation of a video generation system of FIG. 1 in greater detail as employing the techniques described herein.

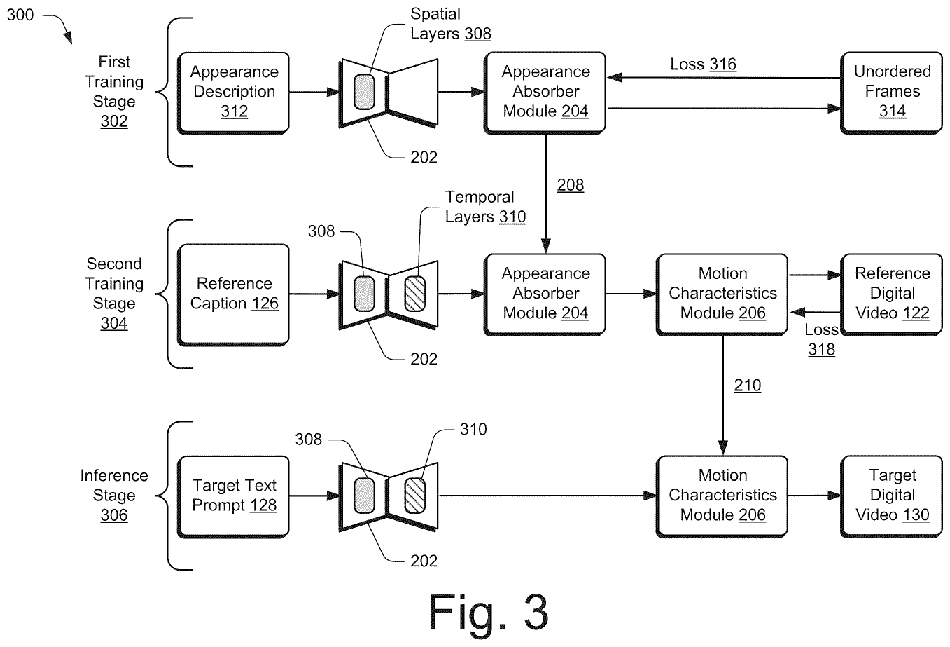

FIG. 3 is a flow diagram depicting an algorithm as a step-by-step procedure in an example implementation of operations performable for accomplishing a result of target digital video generation based on a reference digital video, a reference caption, and a target text prompt.

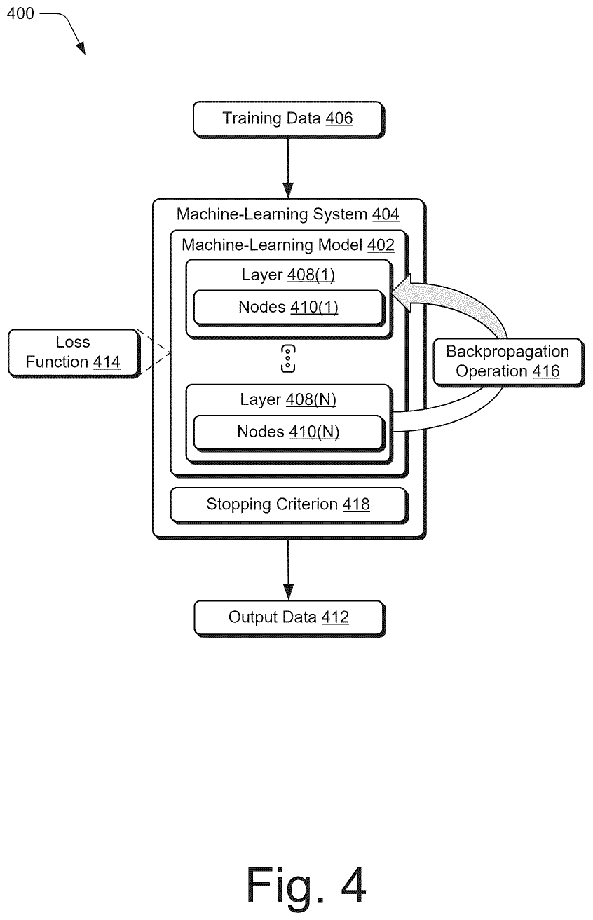

FIG. 4 depicts a system and procedure in an example implementation for training a machine-learning model.

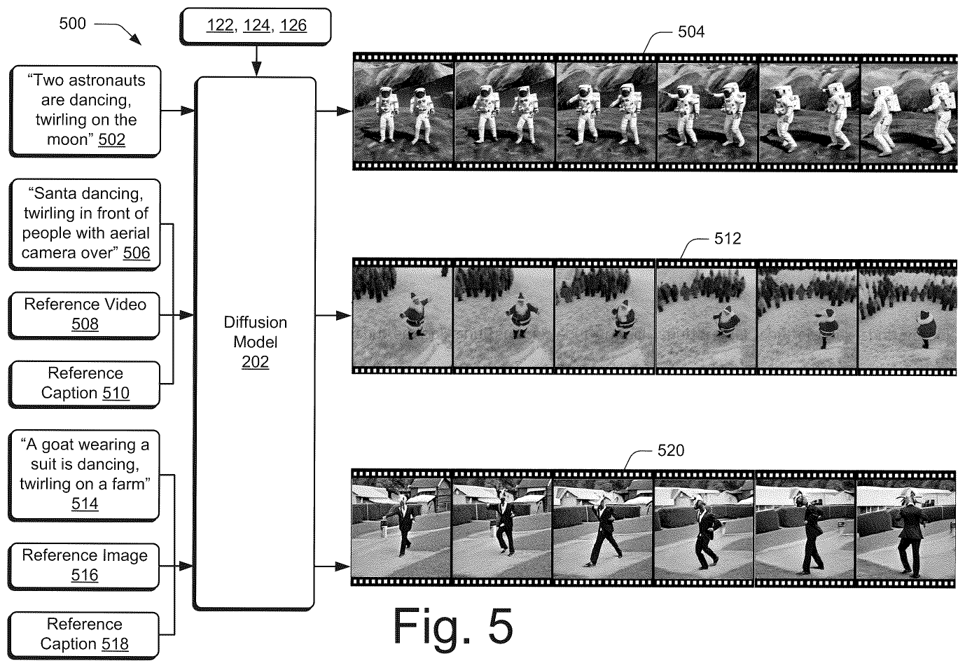

FIG. 5 depicts multiple example implementations to generate target digital videos using the video generation system as employing techniques described herein.

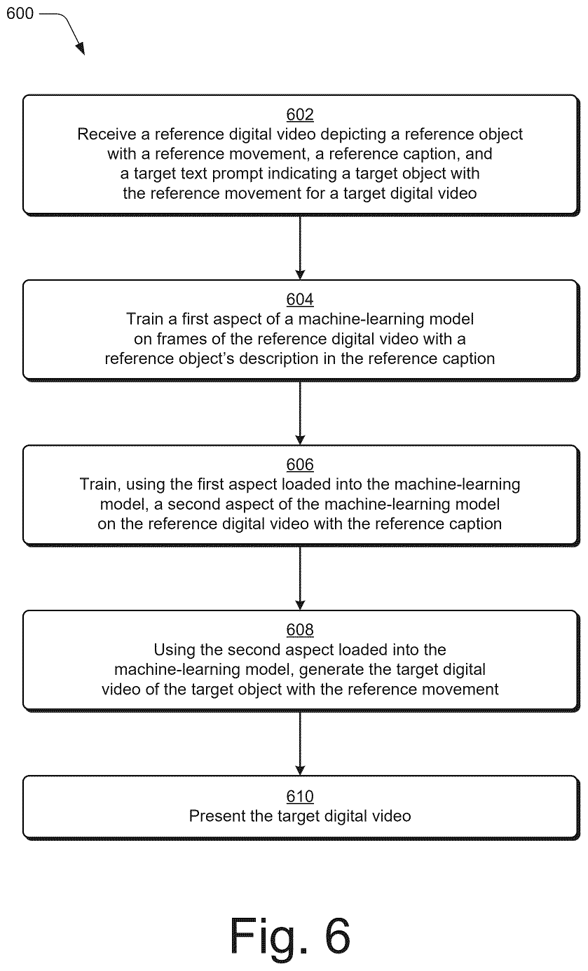

FIG. 6 is a flow diagram depicting an algorithm as a step-by-step procedure in an example implementation of operations performable for accomplishing a result of motion customization in digital video generation.

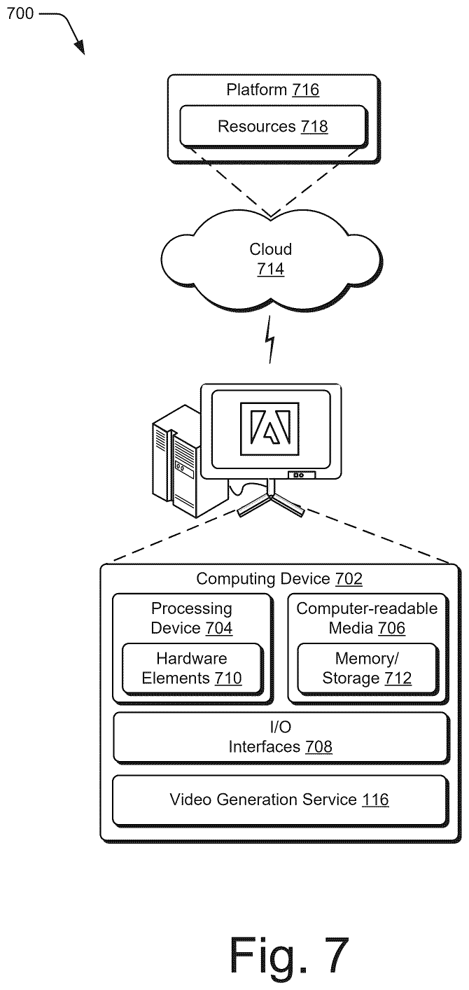

FIG. 7 illustrates an example system including various components of an example device that can be implemented as any type of computing device as described and/or utilize with reference to the previous figures to implement embodiments of the techniques described herein.

### DETAILED DESCRIPTION

### Overview

Generating videos mimicking motion from a reference video is employed by both the movie industry and the visual effects community. One approach is to use text-to-video (T2V) generative diffusion models that generate videos from text prompts that specify the target content and motions. While such machine-learning models have improved in generating imaginative videos based on text depictions, conventional T2V models struggle with precise motion control and require complex prompt engineering. In other words, these conventional creation techniques are limited by a user's ability to define in natural language “what is to be performed” as part of the input to generate desired motions and details.

As another example, some video editing techniques have leveraged the generalization capability of machine-learning models to transfer motion from a source video with variations in appearance and texture to a target video. However, these conventional methods rigidly adhere to the structure and layout of reference frames and lack the ability to provide variability in the motion itself. Such conventional techniques, for instance, often fail to replace an object with a shape and size that is different from the shape and size of another object that is to serve as the replacement. Because of this, these conventional editing techniques often result in visual inaccuracies, incur computational inefficiencies, and increase power consumption.

Accordingly, video creation techniques are described as implemented by a video generation service that leverages motion customization to address these and other technical challenges in generating digital videos. The video generation service customizes a machine-learning model (e.g., a T2V diffusion-based model) using a reference movement learned from a reference digital video. This model customization enables the machine-learning model to be easily adjusted to different subjects and environments. The described techniques provide precise movement transfer and variations in motion intensities, positions, object quantity, and camera views. As a result, the generated videos are more dynamic and engaging, as opposed to the robotic or unnatural appearance of videos created using some conventional techniques.

In particular, the described video generation service leverages low-rank adaptation (LoRA), which is an image customization technique, applied to a pre-trained T2V diffusion model to capture the motion signature in the reference digital video. In one aspect, LoRA is applied on temporal attentional layers to train the T2V diffusion model to the temporal motion dynamics of reference movements in reference digital videos. To disentangle the spatial and temporal information during the training pipeline, appearance absorbers detach the original appearance of the reference object from the respective reference digital video before motion learning. In other words, the appearance information is absorbed, leaving only the motion information for the LoRA. In a subsequent inference stage, the trained machine-learning model generates digital videos of desired target objects with the reference movement. The described staged pipeline also enables video generation adaptable to different subjects and scenes with both spatial and temporal varieties.

In one or more examples, inputs are received by a video generation system that is configured to generate a target digital video, e.g., using generative artificial intelligence as implemented using one or more diffusion models. The inputs include a reference digital video having multiple frames depicting a reference object with a reference movement, a reference caption describing the reference object and the reference movement, and a target text prompt indicating a target object with the reference movement for the target digital video.

The reference digital video, for instance, depicts a lady in a blue dress who is dancing and twirling in front of a small crowd. The reference caption describes the reference digital video as “a lady in a blue dress dancing and twirling in front of an audience.” In this example, the reference object is “a lady in a blue dress in front of an audience,” and the reference movement is “dancing and twirling.” The target text prompt describes “Ironman is dancing and twirling in a park.” The video generation system is tasked with replacing the lady in the blue dress with Ironman dancing and twirling in a park in a manner similar to the reference movement in the reference digital video.

The machine-learning model trains a first aspect of the machine-learning model on frames of the reference digital video with the reference object's description (e.g., a lady in a blue dress) in the reference caption. For example, the first aspect is trained to identify the appearance of the dancing lady and the background environment in the reference digital video using the “a lady in a blue dress” description from the reference caption. In particular, an appearance absorber is loaded into a T2V diffusion model and trained on unordered reference video frames to capture frame-wise spatial information. In this way, the appearance absorber learns to reconstruct the static frames of the reference digital video.

The machine-learning model with the first aspect loaded therein then trains a second aspect of the machine-learning model on the reference digital video with the reference caption. For example, the second aspect learns the motion dynamics associated with the dancing and twirling exhibited by the lady in the reference digital video. In particular, the trained appearance absorber is loaded with fixed parameters, and a temporal LoRA is trained on the temporal layers of the T2V diffusion model. The trained appearance absorber assists the temporal LoRA to focus on temporal signals (e.g., motion information or dynamics), minimizing the spatial information leaked into the motion customization.

Using the trained second aspect loaded therein, the machine-learning model generates the target digital video depicting the target object with the reference movement based on the target text prompt. For example, the dancing and twirling motion dynamics are used to generate a target digital video showing Ironman dancing and twirling in a similar manner. In particular, the appearance absorber is removed, and the trained temporal LoRA is loaded into the T2V diffusion model. Given the target text prompt describing a different subject (or scene), the trained T2V diffusion model generates the target digital video. The trained diffusion model accurately transfers the learned motion information to different objects (e.g., Ironman) and produces diverse motions regarding their intensities, positions, and camera views.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Digital Video Generation Environment

FIG. 1 is an illustration of a digital medium environment 100 in an example implementation that is operable to employ motion customization for digital video generation as described herein. The illustrated digital medium environment 100 includes a service provider system 102 and a computing device 104 that are communicatively coupled, one to another, via a network 106. Computing systems for the service provider system 102 and the computing device 104 are configurable in a variety of ways. For instance, computing device 104 is associated with a user, and service provider system 102 is a remote computing system (e.g., one or more servers) configured to employ the described techniques and systems for subject-aware video creation.

A computing system, for instance, is configurable as a desktop computer, laptop computer, mobile device (e.g., assuming a handheld configuration such as a tablet or mobile phone), server, and so forth. Thus, the service provider system 102 or the computing device 104 is capable of ranging from a full-resource device with substantial memory and processor resources (e.g., servers and personal computers) to a low-resource device with limited memory and/or processing resources (e.g., some mobile devices). Additionally, although a single computing device is shown for the computing device 104 and described in instances in the following discussion, a computing system is also representative of a plurality of different devices, such as multiple servers utilized by a business to perform operations “over the cloud” for the service provider system 102 and as further described in relation to FIG. 7.

The service provider system 102 includes a digital service manager module 108 implemented using hardware and software resources 110 (e.g., a processing device and computer-readable storage medium) to support one or more digital services 112. Digital services 112 are made available remotely via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the digital services 112 via the network 106. A result of processing using the digital services 112 is then returned to the computing device 104 via the network 106.

In the illustrated digital medium environment 100, the digital services 112 include a video generation service 116 for generating videos. Although illustrated as implemented remotely by the service provider system 102, functionality of the video generation service 116 is also configurable for implementation locally, e.g., as part of the communication module 114 at the computing device 104. The video generation service 116 is configured to leverage generative artificial intelligence (AI) techniques implemented using a machine-learning model 118 (e.g., one or more diffusion models) to generate digital videos.

To do so, the video generation service 116 uses the machine-learning model 118 to process inputs 120 to generate a target digital video 130. The inputs 120 include a reference digital video 122 that depicts a reference object 124 (e.g., a lady) in multiple frames, a reference caption 126 describing in plain language the reference object 124 and its movement (e.g., “lady in a blue dress is dancing and twirling”), and a target text prompt 128 describing in plain language (e.g., “Ironman dancing and twirling”) the target object (e.g., Ironman) to perform the same or similar movement in the target digital video 130. For example, given a reference digital video 122 capturing a reference movement of the reference object 124 and a reference caption 126 identifying the reference object 124 and the reference movement, the video generation service 116 is tasked with generating the target digital video 130 as compositing a target object identified in the target text prompt 128 with movement similar to the reference movement in the reference digital video 122.

The described video generation service 116 leverages insights and expressiveness supported by the reference object's movement in order to generate a target digital video 130. In the target digital video 130, in one or more examples, the target object follows the movement of the reference object 124, thereby functioning as an edit to the reference digital video 122. Visually, the video generation service 116 swaps an original object or subject in the reference digital video 122 with the target object or subject in the target text prompt 128 realistically and plausibly as part of generating the target digital video 130.

As previously described, some conventional generative digital video editing techniques that employ diffusion models rely solely on a text prompt. Accordingly, conventional techniques are limited by the expressiveness describable by text. As a result, conventional techniques struggle to accurately edit a digital video when the size and shape of a reference object (that is to be replaced) and a target object (used to replace the source object) differ.

Accordingly, to address these and other technical challenges, the video generation service 116 is configured to employ a reference digital video 122 and reference caption 126 identifying the reference object 124 and reference movement as part of generating the target digital video 130. Through the use of the reference caption 126 in relation to the reference digital video 122, the video generation service 116 is configurable to overcome conventional technical challenges through increased expressiveness and improved motion customization in the target digital video 130 over conventional techniques. As a result, the video generation service 116 is configured to overcome conventional technical challenges in support of digital video generation to address variances in shapes and sizes as well as promote temporal consistency between frames of the target digital video 130.

As illustrated, a reference digital video 122 depicts a lady in a blue dress (e.g., the reference object 124) dancing and twirling (e.g., the reference movement). Reference caption 126 describes the reference movement of reference object 124 in the reference digital video 122: “Lady in a blue dress is dancing and twirling.” The target text prompt 128 describes the request for the target digital video 130: “Ironman dancing and twirling.” The reference digital video 122, the reference caption 126, and the target text prompt 128 are used by the video generation service 116 to generate a target digital video 130 of Ironman dancing and twirling. The video generation service 116 is able to do so even though the shapes and sizes of the reference object 124 (e.g., the lady) and the target object (e.g., Ironman) vary. Further discussion of the operation of the video generation service 116 as performing digital video generation with customizable motion based on a target text prompt 128 is described in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Video Generation with Motion Customization

FIG. 2 depicts a system 200 in an example implementation showing the operation of the video generation service 116 of FIG. 1 as employing the techniques described herein. The diffusion model 202, which is an example of the machine-learning model 118 of FIG. 1, uses a motion customization technique based on text-to-video (T2V) diffusion models for a single input video (e.g., the reference digital video 122).

A “diffusion model” is a generative machine-learning model for digital content creation (e.g., target digital videos 130). To train a diffusion model, noise is generally added to training data samples until the data within the training data samples is obscured. The diffusion model is then trained self-supervised to reverse this process based on training data with a text prompt describing the digital content to be created to generate data samples as the digital content corresponding to the text prompt.

T2V diffusion models generate target digital videos from a text prompt. In general, a T2V diffusion model trains a three-dimensional (3D) UNet ϵ_{θ} to generate videos in a series of denoising steps conditioned on an input text prompt. The 3D UNet employs a convolutional neural network (CNN) architecture and generally includes spatial self-frame and cross-frame attention layers, two-dimensional (2D) and 3D convolutions, and temporal cross-frame attention layers. Given a number F of frames x^{1 . . . F} of an input digital video, the 3D UNet is trained by:

$${L}_{θ} = {𝔼}_{{x}^{1 … F} , ϵ , t} [ ‖ ϵ - {ϵ}_{θ} ( {x}^{1 … F} , t , {τ}_{ν} ( y ) ) ‖ ]$$

at each denoising step t=T, . . . , 0, where ϵ˜ [symbol] (0,1) is Gaussian noise, τᵥ is the text encoder and y is the input text prompt.

While using T2V diffusion models to edit or generate digital videos based on text prompts has gained popularity, these conventional techniques often fail when confronted with complex movements. Because the desired movements are prompted exclusively using text, prompt engineering to portray sufficient detail is difficult and tedious. Further, these conventional techniques lack shape awareness and, therefore, fail when the shape and/or size of a target object differs substantially from the shape and/or size of a source object in a source digital video.

The video generation service 116 is configurable to implement the described systems and techniques to address these and other technical challenges. To do so, the video generation service 116 employs the diffusion model 202 with an appearance absorber module 204 and a motion characteristics module 206 to adapt the diffusion model 202 to downstream tasks. In particular, the appearance absorber module 204 and the motion characteristics module 206 customize the pre-trained diffusion model 202 for a single reference digital video 122 by employing low-rank adaptation (LoRA) techniques.

Conventional techniques adapt a single, large-scale pre-trained machine-learning model to multiple downstream applications via fine-tuning, which updates each pre-trained model parameter. As machine-learning models become larger, such fine-tuning becomes a difficult deployment challenge. In contrast to fine-tuning, LoRA freezes or fixes the pre-trained model weights of a machine-learning model and injects trainable rank decomposition matrices into each layer, greatly reducing the number of trainable parameters for downstream tasks. For example, LoRA can greatly reduce the number of trainable parameters by several orders of magnitude and processor memory requirements by several factors. In the diffusion model 202, LoRA applies a residue path of two low-rank matrices B∈ [symbol] ^{d×r}, A∈ [symbol] ^{r×k} in attention layers, whose original weight is W₀∈ [symbol] ^{d×k}, r<<min(d, k). The new forward path is

$$W = {W}_{0} + αΔ W = {W}_{0} + α BA$$

where α is a coefficient adjusting the strength of the added LoRA.

To begin in the example system 200 of FIG. 2, the diffusion model 202 receives a plurality of inputs 120. The inputs 120 include a reference digital video 122 with a source object 124, a reference caption 126, and a target text prompt 128. The video generation service 116 generates a target digital video 130, which transfers the motion of the reference digital video 122 but replaces the reference object 124 with a target object from the target text prompt 128.

The diffusion model 202 learns a motion concept or signature from the reference object 124 in the reference digital video 122 through the motion characteristics module 206, designed for the temporal layers of the diffusion model 202. The temporal LoRA (T-LoRA) techniques are applied on each temporal cross-frame attention layer of the 3D U-Net in the diffusion model 202 to improve the modeling of the temporal signals 210. The T-LoRA targets motion preservation while discarding unnecessary input appearance.

In other words, the motion characteristics module 206 learns temporal signals 210 (e.g., a motion signature) of the reference object 124 from the reference digital video 122. This motion learning enables the diffusion model 202 to adjust to different subjects and scenes easily via the target text prompt 128. The motion customization includes precise motion transfer from the reference object 124 via the temporal signals 210 to a target object and variations in motion intensities, positions, the number of subjects, and camera views. These variations on motion transfer result in target digital videos 130 that are more dynamic and engaging, as opposed to the robotic or unnatural appearance of per-frame replication in many conventional techniques.

Because spatial and temporal information are learned simultaneously, applying motion concepts directly to T2V diffusion models is often unable to preserve or regenerate the desired motion. This potential pitfall results from spatial and temporal characteristics in the reference digital video being intricately entangled. Accordingly, the diffusion model 202 uses the appearance absorber module 204 to disentangle or separate spatial signals 208 (e.g., spatial information) from the temporal signals 210 (e.g., motion information) in the reference digital video 122. In other words, the appearance absorber module 204 absorbs the spatial signals 208, including the identity, texture, scene, etc., out of the reference digital video 122 to enable the motion characteristics module 206 to model the reference movement exclusively.

The appearance absorber module 204 uses image customization techniques including spatial LoRA (S-LoRA) and textual inversion. The S-LoRA is applied on spatial attention layers alone in the 3D U-Net of the diffusion model 202 to extract the spatial signals 208 out of unordered video frames from the reference digital video 122. To achieve this, LoRA modules are injected in each self-attention layer of the frames and cross-attention layers between frames. Textual inversion gathers spatial features from the reference digital video 122. In particular, textual inversion creates learnable placeholder tokens, initialized with briefly depicting words of the video appearance (e.g., subject description of the reference caption 126), to assimilate relevant spatial signals 208 via the pre-trained text tokenizer. In combination, these image customization techniques are adept at modeling spatial signals 208 from a limited number of frames of a single reference video.

The three-stage training and inference pipelines for the diffusion model 202 to connect the appearance absorber module 204 and the motion characteristics module 206 are described in greater detail with respect to FIG. 3. In one or more examples, the diffusion model 202 is employed after being trained as further described below in relation to FIG. 4.

FIG. 3 is a flow diagram depicting an algorithm as a step-by-step procedure 300 in an example implementation of operations performable for accomplishing a result of target digital video generation based on a reference digital video, a reference caption, and a target text prompt. As described above, the diffusion model 202 learns the source movement from the reference digital video 122 using the motion characteristics module 206 designed for temporal layers 310 of the diffusion model 202. The appearance absorber module 204 disentangles the spatial signals 208 from the reference movement. The procedure 300 includes a first training stage 302, a second training stage 304, and an inference stage 306 for customizing motion in digital videos.

As described above, the diffusion model 202 includes a 3D U-Net to perform denoising as part of the diffusion process. The 3D U-Net employs a convolutional neural network (CNN) architecture designed to process 3D data (e.g., width, height, and depth) of the input data. The 3D U-Net includes spatial layers 308 (e.g., spatial self-attentions and spatial cross-attentions), 2D and 3D convolution layers, and temporal layers 310 (e.g., temporal cross-frame attentions). The spatial layers 308 extract spatial features (e.g., spatial signals 208) from the data to identify patterns and relationships between neighboring regions (e.g., voxels or pixels). In contrast, the temporal layers 310 apply 3D convolutions across the time dimension (e.g., across digital video frames) to capture temporal dependencies (e.g., temporal signals 210) within the data.

In the first training stage 302, the appearance absorber module 204 is trained. The training occurs by bypassing the temporal layers 310 in the diffusion model 202, including the temporal layers 310 and 3D convolution layers in the denoising 3D U-Net. The appearance absorber module 204 is trained with the appearance description 312 of the reference object 124 in reference caption 126 to focus the appearance absorber module 204 on the spatial information to be learned. For example, motion-related words (e.g., action verbs and adverbs) are removed from the reference caption 126. Continuing the example from FIG. 1, the appearance description 312 is “a lady in a blue dress.”

The input images for training the appearance absorber module 204 are unordered frames 314 from the reference digital video 122. In one implementation, S-LoRA and textual inversion techniques are used for the appearance absorber module 204 for their ability to model the spatial signals 208 from a limited number of frames in a single digital video. In other implementations, other appearance-absorbing techniques are employed individually or jointly. The appearance absorber module 204 uses loss 316 (e.g., native or original loss) to train each technique or sub-module in the appearance absorber module 204. For S-LoRA, the loss 316 is:

$${L}_{Δ {θ}_{s}} = {𝔼}_{x , ϵ , t} [ ‖ ϵ - {ϵ}_{{θ}_{o} + Δ {θ}_{s}} ( {x}_{t}^{f} , t , {τ}_{ν} ( y ) ) ‖ ]$$

and for the textual inversion, the loss 316 is:

$${L}_{Δ ν} = {𝔼}_{x , ϵ , t} [ ‖ ϵ - {ϵ}_{θ} ( {x}_{t}^{f} , t , {τ}_{{ν}_{o} + Δ ν} ( y ) ) ‖ ]$$

In the second training stage 304, the trained appearance absorber module 204, including the S-LoRA and textual inversion modules, is loaded into the diffusion model 202 and maintained in a fixed or constant state. The motion characteristics module 206 is inserted into the temporal layers 310 of the diffusion model 202. The motion characteristics module 206 is trained with the reference digital video 122 and the reference caption 126, which includes motion verbs and appearance nouns (e.g., “A lady in a blue dress is dancing and twirling”). The appearance language in reference caption 126 triggers the motion characteristics module 206 to output spatially customized content in static frames. A loss 318 (e.g., reconstruction loss) is used to train the T-LoRA of the motion characteristics module 206, which loss 318 is:

$${L}_{Δ {θ}_{t}} = {𝔼}_{{x}^{1 … F} , ϵ , t} [ ‖ ϵ - ( {ϵ}_{θ + Δ {θ}_{t}} ( {x}_{t}^{1 … F} , t , {τ}_{ν} ( y ) ) ) ‖ ]$$

During the inference stage 306, the trained motion characteristics module 206 (e.g., the trained T-LoRA) is loaded alone into the diffusion model 202. In other words, the appearance absorber module 204 is not loaded into the diffusion model 202. Given the target text prompt 128 describing the learned reference movement with a different appearance or object, the customized diffusion model 202 generates the target digital video 130 after the denoising process of the 3D U-Net. Because of the customized or trained residual weights in the motion characteristics module 206, the reference movement with diversity in motion intensities, positions, and camera views is transferred to the target object in the target digital video 130.

FIG. 4 depicts a system and procedure in an example implementation 400 for training a machine-learning model 402 as part of the machine-learning model 118 of FIG. 1 or the diffusion model 202, the appearance absorber module 204, or the motion characteristics module 206 of FIG. 2. The machine-learning model 402 is illustrated as implemented as part of a machine-learning system 404. The machine-learning system 404 is representative of functionality to generate training data 406, use the generated training data 406 to train the machine-learning model 402, and/or use the trained machine-learning model 402 as implementing the functionality described herein.

As described above, machine-learning models and diffusion models are configurable to perform a wide range of video-related tasks without being explicitly programmed for each one. To train the diffusion model, the underlying machine-learning model 402 is provided with training data 406 that includes examples of images and/or videos to train and retrain the model to generate desired images and/or videos. Over time, the model, once trained, is configured to generate digital videos that are coherent, contextually relevant, and mimic the style and content of the training data, and so forth.

In the illustrated example, the machine-learning model 402 is configured using a plurality of layers 408(1), . . . , 408(N) having, respectively, a plurality of nodes 410(1), . . . , 410(N). The plurality of layers 408(1)-408(N) are configurable to include an input layer, an output layer, and one or more hidden layers. Calculations are performed by the nodes 410(1)-410(N) within the layers via hidden states through a system of weighted connections that are “learned” during training to implement a variety of tasks (e.g., caption generation).

In order to train the machine-learning model 402, training data 406 is received that provides examples of “what is to be learned” by the machine-learning model 402, i.e., as a basis to learn patterns from the data. The machine-learning system 404, for instance, collects and preprocesses the training data 406 that includes input features and corresponding target labels, i.e., of what is exhibited by the input features. The machine-learning system 404 then initializes the parameters of the machine-learning model 402, which the machine-learning system 404 uses as internal variables to represent and process information during training and represent interferences gained through training. In an implementation, the training data 406 is separated into batches to improve the processing and optimization efficiency of the parameters during training.

The training data 406 is then received as input and used to generate predictions based on the current state of parameters of layers 408(1)-408(N) and corresponding nodes 410(1)-410(N) of the model. The machine-learning model 402 outputs its result as output data 412. Output data 412 describes an outcome of the task (e.g., generating a target digital video).

Training the machine-learning model 402 includes calculating a loss function 414 to quantify a loss associated with operations performed by nodes 410 of the machine-learning model 402. Calculating the loss function 414, for instance, includes comparing a difference between predictions specified in the output data 412 with target labels specified by the training data 406. The loss function 414 is configurable in a variety of ways, including regression, the quadratic loss function as part of a least squares technique, and so forth.

Calculating the loss function 414 also includes using a backpropagation operation 416 to minimize the loss function 414, thereby training the parameters of the machine-learning model 402. Minimizing the loss function 414 includes adjusting the weights of the nodes 410(1)-410(N) in order to minimize the loss and thereby optimize the performance of the machine-learning model 402 for a particular task. The adjustment is determined by computing a gradient of the loss function 414, which indicates a direction to be used in order to adjust the parameters for minimizing the loss. The parameters of the machine-learning model 402 are then updated based on the computed gradient.

This process continues over a plurality of iterations until a stopping criterion 418 is met. The stopping criterion 418 is employed by the machine-learning system 404 in this example to reduce overfitting of the machine-learning model 402, reduce computational resource consumption, and promote an ability to address previously unseen data, i.e., that is not included specifically as an example in the training data 406. Examples of a stopping criterion 418 include but are not limited to a predefined number of epochs, validation loss stabilization, achievement of a performance improvement threshold, or based on performance metrics such as precision and recall.

FIG. 5 depicts multiple example implementations 500 to generate target digital videos using the video generation system as employing techniques described herein. The diffusion model 202 of the video generation system (e.g., the video generation service 116 of FIG. 1) receives as inputs the reference digital video 122 with the reference object 124 and the reference caption 126 as depicted in FIG. 2. As described above, the reference digital video 122 depicts a lady in a blue dress (e.g., the reference object 124) dancing and twirling (e.g., the reference movement). The reference caption 126 describes the reference movement of reference object 124 in the reference digital video 122 as: “Lady in a blue dress is dancing and twirling.” In the example implementations 500, the target text prompt 128 is replaced with different target text prompts to generate different target videos mimicking the dancing and twirling in the reference digital video 122, but with different objects, camera views, and/or backgrounds.

In a first example implementation, a target text prompt 502 identifies a different environment, reference object, and quantity of reference objects. In the illustrated example, the target text prompt 502 states: “Two astronauts are dancing, twirling on the moon.” Using the motion customization techniques described above, the diffusion model 202 generates a target digital video 504 models the reference movement (e.g., dancing, twirling) of the reference object 124 (e.g., lady in a blue dress) onto multiple objects without additional editing controls.

In a second example implementation, multiple movements are customized into a target digital video. In addition to inputs 122, 124, and 126, a target text prompt 506 identifies a different environment, reference object, and camera view. The target text prompt 506 states: “Santa dancing, twirling in front of people with aerial camera over.” A first instance of the diffusion model 202 customized on the inputs 122, 126, and a first portion of target text prompt 506 (e.g., Santa dancing, twirling in front of people) generates a digital video of Santa dancing, twirling in front of people.

The inputs also include another reference video 508 and another reference caption 510. The reference video 508 depicts an aerial camera flight over a herd of sheep in a meadow. The accompanying reference caption 510 states: “Aerial camera over a herd.” A second instance of the diffusion model 202 customized on the inputs 508, 510, and a second portion of target text prompt 506 (e.g., aerial camera over) to generate a digital video of a camera flying over a target object (e.g., Santa). The base diffusion model 202 is then customized with the two trained motion characteristics modules 206 from the above instances to integrate various movements (e.g., dancing, twirling, and aerial camera) into one target digital video 512.

In a third example implementation, motion customization and image customization are combined into a target digital video. In addition to inputs 122, 124, and 126, a target text prompt 514 is received, identifying a different environment and a different reference object. The target text prompt 514 states: “A goat wearing a suit is dancing, twirling on a farm.” The diffusion model 202 is customized on inputs 122 and 126 and the target text prompt 514, and then generates a digital video of a different object dancing and twirling on a farm.

The inputs also include one or more reference images 516 and another reference caption 518. The reference images 516 depict animals dressed in different adult clothes. The accompanying reference caption 518 states: “Dressed animals.” A conventional image customization machine-learning model customized on the inputs 516, 518, and a portion of target text prompt 514 (e.g., goat wearing a suit) is to generate a customized image of the target object. The base diffusion model 202 is then customized with the trained motion characteristics module 206 and the customized target object to support both appearance and motion customization, generating target digital video 520. The target digital video 520 shows a goat in a suit on its hind legs as it dances and twirls on a farm.

### Example Video Generation Procedures

The following discussion describes video generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm, e.g., responsive to execution of the instructions. In portions of the following discussion, reference will be made to FIGS. 1-5.

FIG. 6 is a flow diagram depicting an algorithm as a step-by-step procedure 600 in an example implementation of operations performable for accomplishing motion customization in video generation. To begin in this example, a processing device receives a reference digital video, reference caption, and target text prompt are received (block 602). The reference digital video 122 depicts a reference object 124 with a reference movement in multiple frames. The reference caption 126 describes in plain text the reference object 124 and the reference movement. The target text prompt 128 describes in plain text a target object to perform the same or similar movement in the target digital video 130.

A first aspect of a machine-learning model is trained on frames of the reference digital video with a reference object's description in the reference caption (block 604). For example, the appearance absorber module 204 of the diffusion model 202 is trained to identify the spatial signals 208. The training is performed on unordered frames of the reference digital video 122 and the appearance description in the reference caption 126.

Using the first aspect loaded into the machine-learning model, a second aspect of the machine-learning model is trained on the reference digital video with the reference caption (block 606). In particular, the trained appearance absorber module 204 is loaded into the diffusion model 202 with fixed parameters. The motion characteristics module 206 is then trained to identify the temporal signals 210 on the reference digital video 122 with the reference caption 126.

Using the second aspect loaded into the machine-learning model, the machine-learning model generates the target digital video depicting the target object with the reference movement (block 608). For example, the trained motion characteristics module 206 is loaded into the diffusion model 202 without the appearance absorber module 204. The diffusion model 202 generates the target digital video 130 of the target object with the reference movement. The processing device then presents the target digital video, e.g., for display via a user interface (block 610).

### Example System and Device

FIG. 7 illustrates an example system 700 that includes an example computing device 702 that is representative of one or more computing systems and/or devices that are usable to implement the various techniques described herein. This is illustrated through the inclusion of the video generation service 116. The computing device 702 is configurable, for example, as a server of a service provider, a device associated with a client (e.g., a client device), an on-chip system, and/or any other suitable computing device or computing system.

The example computing device 702, as illustrated, includes a processing system 704, one or more computer-readable media 706, and one or more I/O interfaces 708 that are communicatively coupled, one to another. Although not shown, the computing device 702 further includes a system bus or other data and command transfer system that couples the various components from one to another. For example, a system bus includes any combination of different bus structures, such as a memory bus or memory controller, a peripheral bus, a universal serial bus, and/or a processor or local bus that utilizes various bus architectures. A variety of other examples are also contemplated, such as control and data lines.

The processing system 704 is representative of the functionality to perform one or more operations using hardware. Accordingly, the processing system 704 is illustrated as including hardware elements 710 that are configured as processors, functional blocks, and so forth. This includes example implementations in hardware as an application specific integrated circuit or other logic device formed using one or more semiconductors. The hardware elements 710 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 706 is illustrated as including memory/storage 712. Memory/storage 712 represents memory or storage capacity associated with one or more computer-readable media. In one example, the memory/storage 712 includes volatile media (such as random access memory (RAM)) and/or nonvolatile media (such as read-only memory (ROM), Flash memory, optical disks, magnetic disks, and so forth). In another example, the memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways, as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways, as further described below, to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are stored on or transmitted across some form of computer-readable media. For example, the computer-readable media includes a variety of media accessible to the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computing device 702, such as via a network. Signal media typically embodies computer-readable instructions, data structures, program modules, or other data in a modulated data signal, such as carrier waves, data signals, or other transport mechanisms. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic, and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 710. For example, the computing device 702 is configured to implement particular instructions and/or functions corresponding to the software and/or hardware modules. Accordingly, implementation of a module that is executable by the computing device 702 as software is achieved at least partially in hardware, e.g., through the use of computer-readable storage media and/or hardware elements 710 of the processing system 704. The instructions and/or functions are executable/operable by one or more articles of manufacture (for example, one or more computing devices 702 and/or processing systems 704) to implement techniques, modules, and examples described herein.

The techniques described herein are supportable by various configurations of the computing device 702 and are not limited to the specific examples of the techniques described herein. This functionality is also implementable entirely or partially through the use of a distributed system, such as over a “cloud” 714, as described below.

The cloud 714 includes and/or is representative of a platform 716 for resources 718. The platform 716 abstracts the underlying functionality of hardware (e.g., servers) and software resources of the cloud 714. For example, the resources 718 include applications and/or data that are utilized while computer processing is executed on servers remote from the computing device 702. In some examples, the resources 718 also include services provided over the Internet and/or through a subscriber network, such as a cellular or Wi-Fi network.

The platform 716 abstracts the resources 718 and functions to connect the computing device 702 with other computing devices. In some examples, the platform 716 also serves to abstract scaling of resources to provide a corresponding level of scale to encountered demand for the resources implemented via the platform. Accordingly, in an interconnected device embodiment, the implementation of functionality described herein is distributable throughout the system 1000. For example, the functionality is implementable in part on the computing device 702 as well as via the platform 716 that abstracts the functionality of the cloud 714.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, a reference digital video including a plurality of frames depicting a reference object with a reference movement, a reference caption describing the reference movement and the reference object in the reference digital video, and a target text prompt indicating a target object with the reference movement for a target digital video;
training, with a description of the reference object in the reference caption, a first aspect of a machine-learning model on the plurality of frames of the reference digital video;
training, using the first aspect loaded into the machine-learning model, a second aspect of the machine-learning model with the reference caption, the training occurring on the plurality of frames of the reference digital video;
generating, using the second aspect loaded into the machine-learning model, a plurality of frames of the target digital video depicting the target object with the reference movement based on the target text prompt; and
presenting, by the processing device, the target digital video via a display device.

2. The method of claim 1, wherein the machine-learning model is a pre-trained text-to-video (T2V) diffusion model that includes a convolutional neural network (CNN) to perform a series of denoising steps.

3. The method of claim 2, wherein the CNN is a three-dimensional (3D) U-Net that includes spatial self-frame attention layers, spatial cross-frame attention layers, two-dimensional (2D) convolution layers, 3D convolution layers, and temporal attention layers.

4. The method of claim 3, wherein the first aspect is trained by bypassing the temporal attention layers and the 3D convolution layers of the 3D U-Net.

5. The method of claim 4, wherein a motion-related description of the reference movement is extracted from the reference caption to generate an appearance description for the reference digital video, the appearance description being loaded as a training text input for the training of the first aspect.

6. The method of claim 4, wherein unordered frames of the reference digital video are loaded as training input images for the training of the first aspect.

7. The method of claim 3, wherein the second aspect is trained by:
fixing parameters of the first aspect loaded into the T2V diffusion model; and
inserting the second aspect into the temporal attention layers of the 3D U-Net.

8. The method of claim 7, wherein the reference digital video and the reference caption are training inputs for the training of the second aspect.

9. The method of claim 7, wherein the generating occurs without loading the first aspect into the T2V diffusion model.

10. The method of claim 1, wherein:
the reference caption includes plain language text to describe the reference movement and the reference object; and
the target text prompt includes plain language text to describe the target object with the reference movement, the target text prompt describing the reference movement in a similar way as the reference caption.

11. The method of claim 1, wherein:
the reference caption also describes a first environment depicted in the reference digital video; and
the target text prompt also indicates a second environment to be depicted in the target digital video, the second environment being different than the first environment.

12. The method of claim 1, wherein the method further comprises:
receiving, by the processing device, a reference image depicting the target object or an object similar to the target object and a reference image caption identifying the target object or the object similar to the target object;
training, with a description of the target object or the object similar to the target object in the reference image caption, a third aspect of the machine-learning model on the reference image; and
generating, using the second aspect and the third aspect loaded into the machine-learning model, the plurality of frames of the target digital video depicting the target object with the reference movement based on the target text prompt.

13. The method of claim 1, wherein the method further comprises:
receiving, by the processing device, another reference digital video including another plurality of frames depicting another reference movement and another reference caption describing the other reference movement, wherein the target text prompt indicates the target object with the reference movement and the other reference movement for the target digital video;
training, with a description of the other reference object in the other reference caption, a third aspect of the machine-learning model on the other plurality of frames of the other reference digital video;
training, using the third aspect loaded into the machine-learning model, a fourth aspect of the machine-learning model with the other reference caption, the training occurring on the other plurality of frames of the other reference digital video; and
generating, using the second aspect and the fourth aspect loaded into the machine-learning model, the plurality of frames of the target digital video depicting the target object with the reference movement and the other reference movement based on the target text prompt.

14. A computing device comprising:
a processing device; and
a computer-readable storage medium storing instructions that, in response to execution by the processing device, causes the processing device to perform operations including:
receiving a reference digital video including a plurality of frames depicting a reference object with a reference movement, a reference caption describing in plain text the reference movement and the reference object in the reference digital video, and a target text prompt indicating in plain text a target object with the reference movement for a target digital video; and
presenting the target digital video via a display device, wherein a plurality of frames of the target digital video depicting the target object with the reference movement are generated based on the target text prompt using a second aspect of a diffusion model, wherein a first aspect of the diffusion model is trained on the plurality of frames of the reference digital video with a description of the reference object in the reference caption, wherein the second aspect is trained on the plurality of frames of the reference digital video with the reference caption using the first aspect loaded into the diffusion model.

15. The computing device of claim 14, wherein the first aspect of the diffusion model includes an appearance absorber to separate spatial signals from temporal signals within the reference digital video, the spatial signals identifying an identity of the reference object and environment of the reference digital video.

16. The computing device of claim 15, wherein the second aspect of the diffusion model includes temporal low-rank adaption (T-LoRA) matrices to identify the temporal signals within the reference digital video, the temporal signals identifying motion characteristics of the reference movement in the reference digital video.

17. The computing device of claim 16, wherein the generating occurs without loading the appearance absorber into the diffusion model.

18. One or more computer-readable storage media storing instructions that, responsive to execution by a processing device, causes the processing device to perform operations comprising:
receive a reference digital video including a plurality of frames depicting a reference object with a reference movement in a reference environment, a reference caption describing the reference movement, the reference object, and the reference environment in the reference digital video, and a target text prompt indicating a target object with the reference movement in a target environment for a target digital video;
train, with a description of the reference object and the reference environment in the reference caption, a first aspect of a machine-learning model on the plurality of frames of the reference digital video;
train, using the first aspect loaded into the machine-learning model, a second aspect of the machine-learning model with the reference caption, the training occurring on the plurality of frames of the reference digital video;
generate, using the second aspect loaded into the machine-learning model, a plurality of frames of the target digital video depicting the target object with the reference movement in the target environment based on the target text prompt; and
present the target digital video via a display device.

19. The one or more computer-readable storage media of claim 18, wherein the first aspect is trained by bypassing temporal attention layers and three-dimensional (3D) convolution layers of the machine-learning model.

20. The one or more computer-readable storage media of claim 19, wherein the second aspect is trained by:
fixing parameters of the first aspect loaded into the machine-learning model; and
inserting the second aspect into temporal attention layers of the machine-learning model.
